(19) United States
(12) Patent Application Publication
(10) Pub. No.: US 2008/0167984 A1
(43) Pub. Date: Jul. 10, 2008

(54) Zero recovery credit default swap indices

(76) Inventors: Matthew Courey, London (GB); Matthew Piper, London (GB)

Correspondence Address: KIRKPATRICK & LOCKHART PRESTON GATES ELLIS LLP, 535 SMITHFIELD STREET, PITTSBURGH, PA, 15222, US

(21) Appl. No.: 11/650,186

(22) Filed: Jan. 5, 2007

(51) Int. Cl. G06Q 40/00

(52) U.S. Cl. 705/38

(57) ABSTRACT

A zero recovery credit default swap (CDS) having a portfolio of constituents, where a seller of the CDS agrees to pay a buyer a contingent payment upon each occurrence of a credit event involving a constituent of an underlying index. The contingent payment may equal the notional value times the number of credit events occurring during the period divided by the total number of constituents N.

### BACKGROUND

A credit default swap (“CDS”) is a bilateral contract in which the seller agrees to make a payment to the buyer in the event of a specified credit event in exchange for payments from the buyer. CDSs have been used in the financial industry to transfer risk from one party (the buyer) associated with the buyer's credit exposure to a third party to another party (the seller). Thus, a CDS can act as an insurance policy for the buyer against the risk that the third party may default on their bonds or some other obligation during the term of the CDS. Typically, a CDS contract involves a single reference credit, but CDS indices, such as the iTraxx Crossover Series, that involve numerous reference credits are also known in the art.

CDS contracts may be considered to involve two types of risk. The first risk, the so-called “default risk,” is the risk that the reference company may experience a credit event, such as a bankruptcy, a restructuring of debt, or a failure to make payments upon their outstanding obligations, etc., that invokes the seller's payment obligations. The second risk, the so-called “recovery risk,” is the risk that holders of the reference company's fixed income products or other debt obligations may not be able to recover all or some of the amounts due because of the credit event. The recovery risk associated with a CDS contract is often difficult to price.

Buyers of CDSs are typically obligated to pay a periodic premium payment to the seller based on a notional value for the CDS contract and a spread amount. The periodic premium payment is typically equal to the notional value times the spread amount divided by the number of periods.

In addition to the periodic payments, the seller may also agree to compensate the buyer either through a physical settlement or a cash settlement upon the occurrence of a credit event. A physical settlement is made when the seller buys the underlying obligation from the buyer at the notional value. The seller then attempts to recover whatever cash it can from the underlying obligation. A cash settlement occurs when the seller makes a contingent payment to the buyer. The contingent payment has traditionally been based on the notional value of the CDS contract and a recovery rate R. The contingent payment traditionally has equaled the notional value times (1−R). The settlement of a CDS contract typically occurs 30 to 45 days following the credit event.

### SUMMARY OF THE INVENTION

In one general aspect, the present invention is directed to a zero recovery credit default swap (CDS) having a portfolio of constituents (e.g., an index). In particular, according to one embodiment, the present invention is directed to a method comprising entering into, by a seller, a contract (e.g., a CDS) with a buyer, wherein the buyer agrees to pay periodic premium payments to the seller during the term of the contact, and the seller agrees to pay a contingent payment upon each occurrence of a credit event involving a constituent of the underlying index. In various embodiments of the present invention, the underlying index may comprise a number N constituents. The premium payment may be equal to a spread amount times the notional value divided by the number of periods. The contingent payment may equal the notional value times the number of credit events occurring during the period divided by N.

In various embodiments, the credit event may comprise a bankruptcy, a restructuring, a failure to make payments by a constituent of the underlying index, or some other negative credit event. The occurrence of a credit event may reduce the premium payment amount to be paid by the buyer in future occurring periods by the proportion of the number of credit events occurring during the current period divided by N.

### DESCRIPTION OF THE FIGURES

Embodiments of the present invention are described herein by way of example in conjunction with the following figures, wherein:

FIGS. 1 and 2 illustrate a transaction structure according to various embodiments of the present invention;

FIG. 3 is a diagram of a computer device according to various embodiments of the present invention; and

FIG. 4 is a diagram of a screen shot according to various embodiments of the present invention.

### DETAILED DESCRIPTION OF THE INVENTION

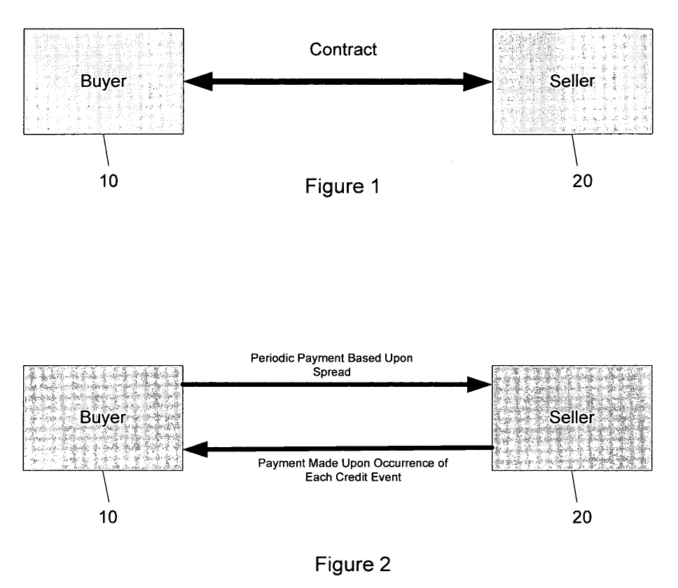

FIGS. 1 and 2 illustrate a transaction structure according to various embodiments of the present invention. As shown in FIG. 1, a buyer 10 enters into a contract (e.g., a CDS) with a seller 20. The contract may reference a number (such as 45) of constituents (e.g. companies). The term of the contract and the portfolio of underlying constituents may be identical to a published index, such as the iTraxx Crossover Series 5.

The contract may require, as shown in FIG. 2, the buyer 10 to make periodic premium payments to the seller 20, and the seller 20 to pay a contingent payment to the buyer 10 upon each occurrence of a credit event involving one of the constituents.

In various embodiments, the contract may require the buyer 10 to make periodic premium payments to the seller 20 during the term of the contract. The periodic premium payments may be based upon a spread amount and a notional value of the contract. The periodic premium payment may be equal to the spread amount times the notional value divided by the number of periods in the contract. The periodic premium payments may be made on an annual basis, on a quarterly basis, or on any other time period on which the buyer and seller may agree. For example, if the notional value were equal to $10 million, the spread equal to 400 basis points, and payments were to be made on a quarterly basis, the periodic premium payments may equal $100,000 (computed by ($10M×0.004)/4) to be paid each quarter.

As mentioned above, the contract may reference a number N constituents, such as 45, and may be identical to a CDS index, such as the iTraxx Crossover Series 5. In various embodiments, the contingent payment may be based upon the notional value, and may be related to the notional value times 1/N for each credit event involving a constituent during the period in question. The period in question may be as short as 3 days. Thus, there would typically be at most one credit event per period, but it is possible that multiple constituents may experience a credit event on the same day or within one day of each other. In such circumstances, the contingent payment would reflect these multiple credit events as the contingent payment may be equal to the notional value times the number of credit events occurring during the period divided by N. For example, if the notional value is $10 million, the number of constituents equals 45, and only one credit event occurred during the period in question, the contingent payment may be $222,222.22 (or 1/45th) of the notional value. The maximum cumulative contingent payment that may be paid by the seller 20 over the course of the underlying index's term may equal the notional amount of the underlying index in such an embodiment.

In various embodiments, the credit event may comprise a bankruptcy, a restructuring, a failure to make payments by a constituent, or some other defined negative credit event. For example, a corporation, which may be a constituent, may file for bankruptcy, restructure its debt in a manner that negatively effects investors, or may even fail to make payments on an outstanding obligation. Such events may be considered credit events that invoke the seller's obligation to make a contingent payment. Settlement of the seller's contingent payment may occur in a time period after the occurrence of a credit event, such as 3 days, or some other shortened time period compared to the typical 30-45 day settlement of a traditional CDS, after the occurrence of a credit event.

As can be seen, in embodiments of the present invention, the recovery risk associated with a credit event for one of the underlying constituents may equal 0% because the contingent payment is not be based upon the amount (if any) recovered due to the credit event. For example, the recovery risk in a traditional CDS contract may be used to calculate the contingent payment, whereas in embodiments of the present invention, the contingent payment may not be based upon any recovery risk.

The occurrence of a credit event may create an obligation on behalf of the seller 20 to pay the contingent payment to the buyer 10. The occurrence of a credit event may also reduce the periodic premium payment amount that may be paid by the buyer 10 to the seller 20 in future occurring periods. The periodic premium payments may be reduced by the proportion of the number of credit events occurring during the current period divided by N. For example, if the notional value were equal to $10 million, the spread equal to 400 basis points, payments were to be made on a quarterly basis, N equals 45, and only one credit event occurred during the period in question, the periodic premium payments may be reduced from $100,000 (computed as ($10M×0.004)/4) to $97,777.78 (computed as ($100,000×(1− 1/45)).

In various embodiments, the contract may have a fixed term, such as 5 years, 10 years, 20 years, etc., that may match the term of an index, such as the iTraxx Crossover Series 5. The constituents of the contract may also match the constituents of the index, as mentioned above. Also, the buyer 10 may be permitted to sell its rights and obligations under the contract to a third party investor. The buyer's 10 permission to sell may continue until the end of the term of the contract. The third party investor may be entitled to offer for resale the rights and obligations acquired from the buyer, until the end of the term of the contract. The buyer's sale and the third party investor's resale may occur in a secondary market.

In various embodiments, buyer 10 and/or seller 20 may perform a breakeven analysis when deciding whether to enter into the contract. For example, if the spread is equal to 400 basis points, N equals 45, and the fixed maturity date is 5 years, the breakeven analysis may show that 1.8 defaults per year, or the spread amount divided by 1/N (or 400/222), is the breakeven point. Over the course of the five year term, the breakeven point may be 9 defaults. In other words, the buyer 10 may have to incur approximately 1.8 defaults per year to breakeven on the contract, so if the buyer 10 projects more than 1.8 defaults per year, then the buyer 10 may choose to enter into the contract with the seller 20. Third party investors may also use the same breakeven analysis to determine whether to purchase the buyer's 10 rights and obligations under the contract.

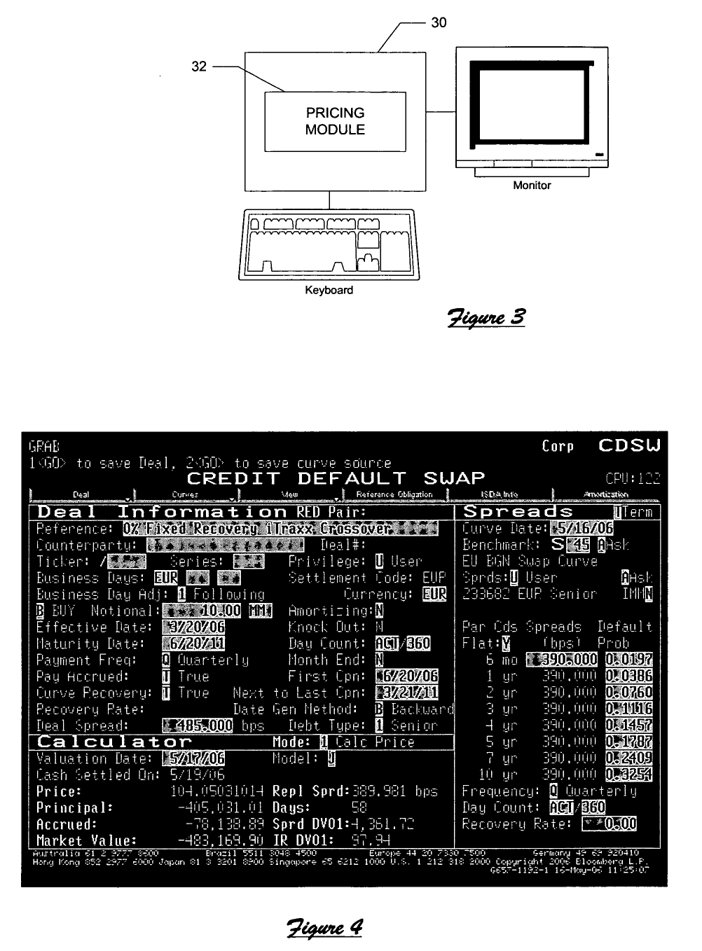

In various embodiments, a party may choose to price the contract based upon a computer-based pricing model, such as shown in FIG. 3. FIG. 3 shows a computer device 30 comprising software for executing the pricing model 32. The pricing model 32 may provide a user interface for data entry, an example of which is shown in FIG. 4. The screen may include pre-populated areas with pre-determined data already existing in those fields. A user 20 may also be able to enter other data into the data fields which are not pre-populated. For example, the user 20 may enter the notional value, the spread amount, and the maturity date. The pricing model 32 may generate a price upon entry of the data by the user. The price may equal the value of the contract at that particular point in time. The pricing model 32 may be implemented as software to be executed by a processor (not shown) of the computer device 30. The software may be stored on a computer readable medium, such as a memory (a RAM or ROM), an optical medium (e.g., a CD), or a magnetic medium (e.g., a hard drive).

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A method comprising:
entering into, by a seller, a contract with a buyer, wherein the buyer agrees to pay periodic premium payments to the seller during the term of the contract, and wherein the seller agrees to pay a contingent payment to the buyer upon each occurrence of a credit event involving a constituent of an underlying index, and wherein the underlying index comprises a number N constituents and the contingent payment is related to a notional value times 1/N for each credit event involving a constituent.

2. The method of claim 1, wherein the premium payment is based upon a spread amount and the notional value.

3. The method of claim 2, wherein the premium payment is equal to the spread amount times the notional value divided by the number of periods.

4. The method of claim 1, wherein the contingent payment is based upon the notional value.

5. The method of claim 4, wherein the contingent payment is equal to the notional value times the number of credit events occurring during the period divided by N.

6. The method of claim 1, wherein the credit event comprises at least one of a bankruptcy, a restructuring, or a failure to make payments by one of the constituents of the underlying index.

7. The method of claim 6, wherein the occurrence of a credit event reduces the premium payment amount to be paid by the buyer in future occurring periods by the proportion of the number of credit events occurring during the current period divided by N.

8. The method of claim 1, wherein the constituents and the term of the contract match the constituents and term of an index.

9. A method comprising:
making periodic premium payments, by a buyer to a seller, pursuant to a contract with the seller, wherein the buyer makes the periodic premium payments to the seller during a fixed maturity term of an underlying index; and
receiving a contingent payment, by the buyer from the seller, wherein upon each occurrence of a credit event involving a constituent of the underlying index, the buyer receives the contingent payment from the seller, and wherein the underlying index comprises a number N constituents, and wherein the contingent payment is related to a notional value times 1/N for each credit event involving a constituent.

10. The method of claim 9, wherein the premium payment is based upon a spread amount and the notional value.

11. The method of claim 10, wherein the premium payment is equal to the spread amount times the notional value divided by the number of periods.

12. The method of claim 9, wherein the contingent payment is based upon the notional value.

13. The method of claim 12, wherein the contingent payment is equal to the notional value times the number of credit events occurring during the period divided by N.

14. The method of claim 9, wherein the occurrence of a credit event reduces the premium payment amount to be paid by the buyer in future occurring periods by the proportion of the number of credit events occurring during the current period divided by N.

15. The method of claim 9, wherein the constituents and the term of the contract match the constituents and term of an index.

16. A method comprising:
receiving periodic premium payments, by a seller from a buyer, pursuant to a contract with the buyer, wherein the seller receives the periodic premium payments from the buyer during a fixed maturity term of an underlying index; and
making a contingent payment, by the seller to the buyer, wherein upon each occurrence of a credit event involving a constituent of the underlying index, the seller makes the contingent payment to the buyer, and wherein the underlying index comprises a number N constituents, and wherein the contingent payment is related to a notional value times 1/N for each credit event involving a constituent.

17. The method of claim 16, wherein the premium payment is based upon a spread amount and the notional value.

18. The method of claim 17, wherein the premium payment is equal to the spread amount times the notional value divided by the number of periods.

19. The method of claim 16, wherein the contingent payment is equal to the notional value times the number of credit events occurring during the period divided by N.

20. The method of claim 16, wherein the occurrence of a credit event reduces the premium payment amount to be paid by the buyer in future occurring periods by the proportion of the number of credit events occurring during the current period divided by N.

21. The method of claim 16, wherein the constituents and the term of the contract match the constituents and term of an index.
